(19) United States
(12) Patent Application Publication
(10) Pub. No.: US 2007/0211420 A1
(43) Pub. Date: Sep. 13, 2007

(54) PORTABLE ELECTRONIC DEVICE

(75) Inventor: Seog BANG, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/681,369

(22) Filed: Mar. 2, 2007

(30) Foreign Application Priority Data
Mar. 8, 2006 (KR) 2006-21956

(51) Int. Cl. G06F 1/16

(52) U.S. Cl. 361/683

(57) ABSTRACT

A portable electronic device includes a main body, a display part provided in the main body and displaying an image thereon, a main stand which is coupled with a rear part of the main body to adjust a supporting angle of the main body, and an auxiliary stand which is coupled with either the main body or the main stand, to adjust the supporting angle of the main body.

### CROSS-REFERENCE TO RELATED APPLICATIONS

This application claims priority under 35 U.S.C. §119(a) from Korean Patent Application No. 2006-0021956, filed on Mar. 8, 2006, in the Korean Intellectual Property Office, the disclosure of which is incorporated herein in its entirety by reference.

### BACKGROUND OF THE INVENTION

1. Field of the Invention

The present general inventive concept relates to a portable electronic device, and more particularly, to a portable electronic device having an improved stand configuration.

2. Description of the Related Art

A portable electronic device provides various functions for a user while moving. With advances in communication, sound, and multimedia technologies, the portable electronic device has been developed to offer various kinds of contents. Also, the portable electronic device has been very popular since it is small in size and light in weight.

The portable electronic device may comprise portable electronic devices, such as, a personal digital assistant (PDA), a portable multimedia player (PMP), a portable video game device, a digital multimedia broadcasting (DMB) device, and an MP3 player. Further, the portable electronic device may also comprise a portable computer, a mobile phone, and a tablet PC, which provide combined functions of the foregoing devices.

FIGS. 1A and 1B illustrate a conventional portable electronic device 50. As illustrated in FIG. 1A, the conventional portable electronic device 50 comprises a display part 10 which displays an image thereon, a main body 20 which supports the display part 10, and a stand 30 which supports the main body 20 to rotate with respect to an installation surface.

The stand 30 of the conventional portable electronic device 50 supports the main body 20 at a viewing angle so that a user views the display part 10 without difficulty. The stand 30 maintains the viewing angle by limiting a rotating angle against the main body 20. When a user inputs information to the display part 20 with a touch screen function, the user inputs the information with a touch pen while the viewing angle is maintained. Thus, the user's wrist may become sore or injured when inputting the information for an extended time.

To solve the foregoing problem, the conventional portable electronic device 50 employs an additional supporter 40, which supports the main body 20 as illustrated in FIG. 1B. In this case, however, a user is required to carry the supporter 40 together with the main body 20 while moving from one place to another, thereby causing inconveniences to the user.

### SUMMARY OF THE INVENTION

The present general inventive concept provides a portable electronic device which comprises an improved supporting configuration to support a main body at an optimal angle according to whether a user receives image information through a display part or inputs information through the display part.

Additional aspects and/or advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a portable electronic device comprising a main body, a display part provided in the main body to display an image thereon, a main stand which is coupled with a rear part of the main body to adjust a supporting angle of the main body, and an auxiliary stand which is coupled with one of the main body and the main stand, to adjust the supporting angle of the main body.

The main stand and the auxiliary stand may be coupled with a same hinge shaft.

The main stand and the auxiliary stand may be coupled with different hinge shafts, respectively.

The portable electronic device may further comprise a main stand supporter having a first end rotatably coupled with the rear part of the main body, and a second end coupled with the main stand, to support the main stand and maintain the supporting angle of the main stand with respect to the main body.

The second end of the main stand supporter may be slidably coupled with the main stand.

The main stand supporter may comprise a coupling shaft accommodator which is formed along a lengthwise direction thereof and accommodates therein a coupling shaft slidably coupled with the main stand, and a stopper provided in a first end of the coupling shaft accommodator to limit a movement of the coupling shaft.

The main stand may comprise a coupling track with which the coupling shaft is slidably coupled.

The main stand supporter may comprise an elastic material.

The main stand may comprise an auxiliary stand accommodator which accommodates the auxiliary stand.

The main stand and the auxiliary stand may be different in height.

The main stand may comprise an auxiliary stand accommodator which accommodates the auxiliary stand when the auxiliary stand is folded to the main body.

The portable electronic device further may comprise a shaft supporter provided in the rear part of the main body to support the hinge shaft of the auxiliary stand.

The portable electronic device may further comprise a pair of projections disposed at a first side of the shaft supporter at a predetermined angle, and a pair of projection accommodating grooves disposed at a hinge shaft accommodator of the auxiliary stand to accommodate the projections and to limit a rotating angle of the auxiliary stand.

The foregoing and/or other aspects and utilities of the present general inventive concept are also achieved by providing a portable electronic device comprising a main body, a display part disposed in the main body to display an image, a main stand rotatably coupled with a rear part of the main body to support a plurality of first angles of the main body with respect to an installation surface, and an auxiliary stand rotatably coupled with one of the main body and the main stand to support a plurality of second angles of the main body with respect to the installation surface.

The main stand may comprise an auxiliary stand accommodation portion to accommodate the auxiliary stand, a plurality of rotating shaft portions to accommodate a first rotating shaft and to rotatably couple the main stand to the main body, and a grip part disposed on an opposite side to the rotating shaft portions to allow a user to rotate the main stand.

The auxiliary stand may comprise a plurality of rotating shaft couplers to accommodate a second rotating shaft and to rotatably couple the auxiliary stand to the main body, and a grip part disposed on an opposite side to the rotating shaft couplers to allow a user to rotate the main stand.

The first rotating shaft and the second rotating shaft may comprise the same shaft, and the plurality of rotating shaft couplers may be disposed between the plurality of rotating shaft portions.

The device may further comprise a main stand supporter having a first end rotatably coupled to the rear part of the main body and a second end slidably coupled to the main stand, to support the main stand and maintain the plurality of first angles of the main stand with respect to the main body.

The main stand supporter may comprise a second rotation shaft accommodator to accommodate a shaft and to rotatably couple the main stand supporter to the main body, and a coupling shaft accommodator to accommodate a coupling shaft to slidably couple the main stand supporter to the main stand.

The main stand may further comprise coupling track to guide the coupling shaft.

The coupling shaft accommodator may further comprise a stopper to restrict the rotation of the main stand at the plurality of first angles.

The foregoing and/or other aspects and utilities of the present general inventive concept are also achieved by providing a portable electronic device, comprising a main body, a display part disposed in the main body to display an image, and a stand unit rotatably coupled with a rear part of the main body and including a first part to rotate out from the main body to provide a first set of angles to support the main body with respect to an installation surface and a second part to rotate out from the main body to provide a second set of angles to support the main body with respect to the installation surface.

The first part and the second part of the stand unit may be together rotatably coupled at first respective sides thereof to the rear portion of the main body.

The stand unit may further comprise a shaft to rotatably couple the first and second part of the stand unit together to the rear portion of the main body.

The portable electronic device may further comprise a shaft supporter disposed at the rear portion of the main body to support the stand unit and to support the second set of angles.

The shaft supporter may be integrally formed with the rear portion of the main body.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A and 1B are schematic perspective views illustrating a supporting configuration of a conventional portable electronic device;

FIGS. 2A and 2B are perspective views illustrating a portable electronic device according to the present general inventive concept;

FIG. 3 is an exploded perspective view illustrating the portable electronic device of FIGS. 2A and 2B;

FIGS. 4A and 4B are an enlarged perspective and enlarged sectional views illustrating a main stand supporter in FIG. 3;

FIG. 5 illustrates an operation of a main stand according to an embodiment of the present general inventive concept; and

FIGS. 6A and 6B illustrate an operation of an auxiliary stand according to an embodiment of the present general inventive concept.

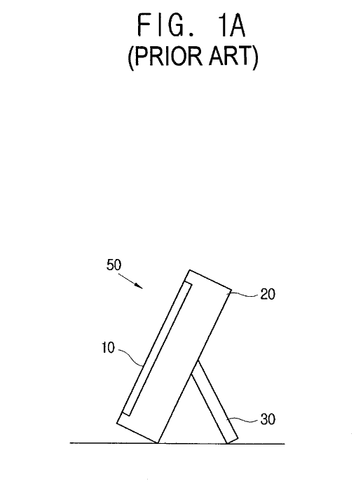

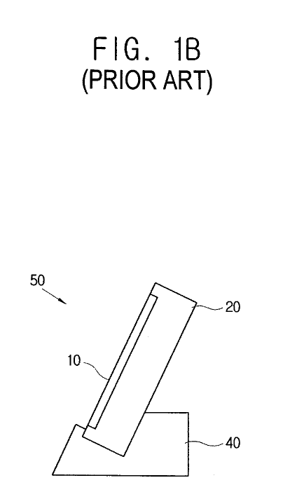

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

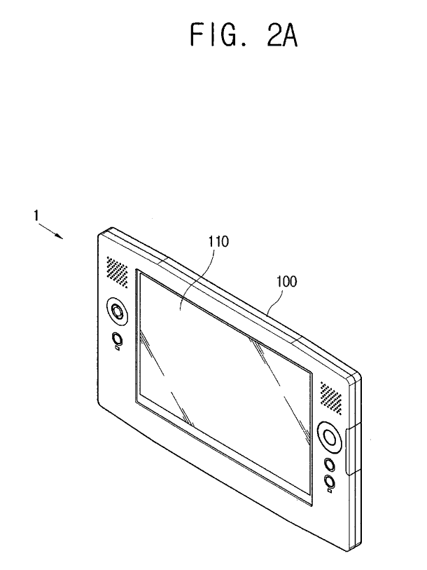

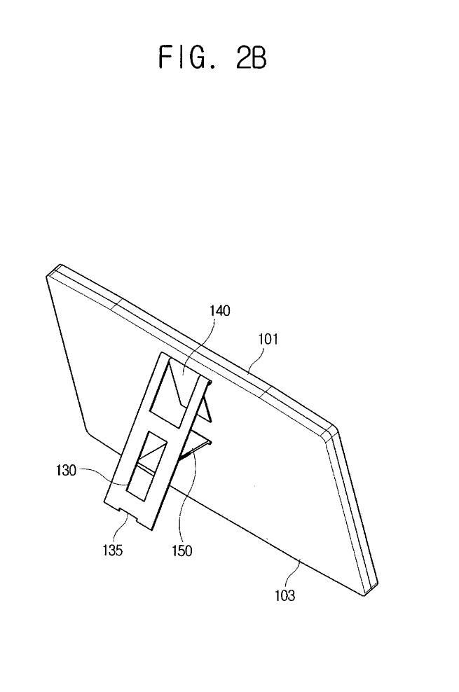

FIGS. 2A and 2B are perspective views illustrating a portable electronic device 1 according to the present general inventive concept. As illustrated therein, the portable electronic device 1 may comprise a display part 110, a main body 100 which supports the display part 110, a main stand 130 which is rotatably coupled with a rear part of the main body 100 to adjust a viewing angle so that a user may receive image information through the display part 110, an auxiliary stand 140 which is rotatably coupled with the rear part of the main body 100 to adjust an information input angle so that a user may input information through the display part 110, and a main stand supporter 150 which supports the main stand 130 to maintain the viewing angle.

The display part 110 may comprise a display panel such as, a liquid crystal display (LCD), a plasma display panel (PDP), and an organic light emitting diode (OLED).

The main body 100 supports the display part 110. The main body 100 may comprise a central processing unit (CPU) to process information, a storage part (not illustrated) to store information therein, a communication unit (not illustrated) to communicate with other devices, and a circuit board (not illustrated). Elements of the main body 100 may vary according to types and functions of the portable electronic device 1.

The main body 100 may comprise a front casing 101 which supports the display part 110, and a rear casing 103 which is coupled with the front casing 101. The front casing 101 supports the display part 110. The rear casing 103 is coupled with the main stand 130, the auxiliary stand 140, and the main stand supporter 150. The rear casing 103 may comprise an accommodating part (not illustrated) which corresponds to a shape of the main stand 130, the auxiliary stand 140, and the main stand supporter 150 to accommodate them when folded to the main body 100. The accommodating part may be depressed in a plate surface of the rear casing 103, thereby reducing the thickness of the main body 100.

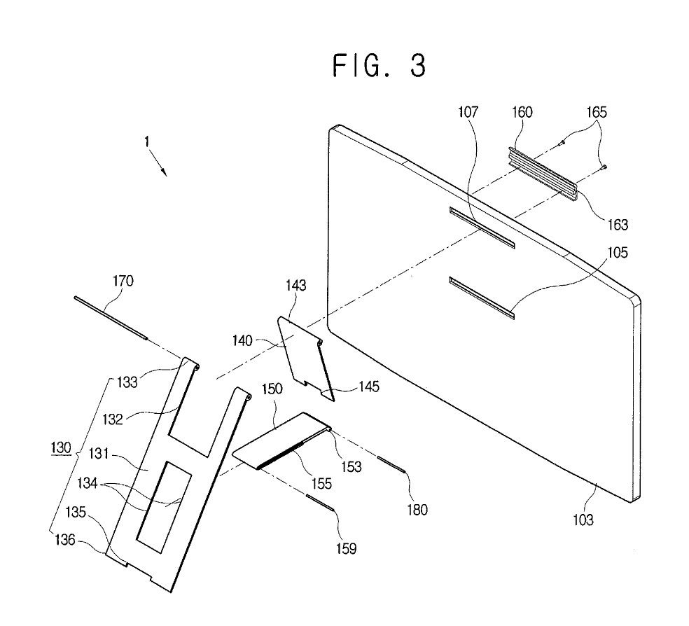

Referring to FIG. 3, the rear casing 103 may comprise a first rotating shaft accommodator 107 which accommodates a first rotating shaft 170 to rotate the main stand 130 and the auxiliary stand 140, and a second rotating shaft accommodator 105 which accommodates a second rotating shaft 180 to rotate the main stand supporter 150. While FIG. 3 illustrates the first rotating shaft accommodator 107 as formed in the rear casing 103, the present general inventive concept is not limited thereto, and the first rotating shaft accommodator 107 can alternatively be provided in a shaft supporter 160 which will be described later.

The front casing 101 and the rear casing 103 may comprise a synthetic resin to make the main body 100 light.

As illustrated in FIG. 3, the shaft supporter 160 may be coupled with the rear casing 103. The shaft supporter 160 accommodates and supports a rotating shaft coupler 133 of the main stand 130 and opposite ends of the first rotating shaft 170 that penetrates a rotating shaft coupler 143 of the auxiliary stand 140. The shaft supporter 160 may comprise a projection 163 which protrudes to the outside of the main body 100 to correspond to the rotating shaft coupler 143 of the auxiliary stand 140, thereby limiting the rotating angle of the auxiliary stand 140.

The shaft supporter 160 may be coupled with the rear casing 103 through various methods including screws 165. The shaft supporter 160 may also be integrally formed with the rear casing 103.

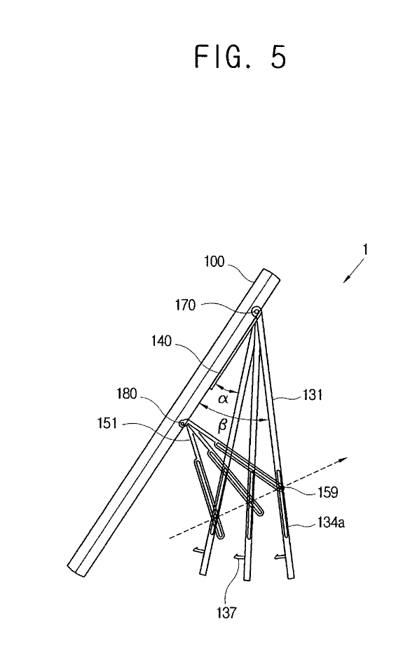

The main stand 130 can be rotatably coupled with the rear casing 103 and adjusts the viewing angle so that a user may view image information through the display part 110. The main stand 130 may comprise a stand main body 131 which may have a plate shape, an auxiliary stand accommodator 132 which may be provided in an upper part of the stand main body 131, the rotating shaft coupler 133 which may be provided on opposite ends of the auxiliary stand accommodator 132 and coupled with the first rotating shaft 170, and a guide 134 which is slidably coupled with a second end of the main stand supporter 150. The main stand 130 may also comprise a hook 137 to maintain a coupling state with the main body 100 when folded to the rear casing 103 (see FIG. 5).

The stand main body 131 may have a plate shape. The stand main body 131 may comprise a material which is durable to support the main body 100. The stand main body 131 may be thin to make the main body 100 slim. The stand main body 131 may have a thickness to be at a same level with the plate surface of the rear casing 103 when folded to the rear casing 103 and accommodated in the accommodating part in the rear casing 103. Thus, a user may carry the portable electronic device 1 without difficulty, and an external appearance thereof becomes simple.

The auxiliary stand accommodator 132 may be provided in the upper part of the stand main body 131 to accommodate the auxiliary stand 140 when folded to the rear casing 103. While the auxiliary stand 140 as illustrated in FIG. 3 shares the same rotating shaft 170 with the main stand 130, but the present general inventive concept is not limited thereto. Alternatively, the auxiliary stand accommodator 132 may correspond to a position of the auxiliary stand 140 when the auxiliary stand 140 is provided within a rotating radius of the main stand 130 having a different rotating shaft.

The auxiliary stand accommodator 132 accommodates the auxiliary stand 140 when folded to the rear casing 103. The auxiliary stand accommodator 132 may have a size not to interrupt the auxiliary stand 140 when the auxiliary stand 140 rotates. The auxiliary stand accommodator 132 may form an accommodating space bigger than the auxiliary stand 140.

The rotating shaft coupler 133 may be provided in an upper part of the opposite ends of the auxiliary stand accommodator 132, and accommodates the first rotating shaft 170 coupled with the rotating shaft coupler 143 of the auxiliary stand 140 and is supported by the shaft supporter 160. The rotating shaft coupler 133 rotates around the first rotating shaft 170 and provides a user with an optimal viewing angle. Here, the main stand supporter 150 limits the rotating angle of the rotating shaft coupler 133. The rotating angle of the main stand 130 may be 40° at maximum. Alternatively, the rotating angle of the main stand 130 may be adjusted as necessary.

The guide 134 is provided in a lower part of the auxiliary stand accommodator 132 and corresponds to the main stand supporter 150. A coupling track 134a (refer to FIG. 5) is provided on opposite sides of the guide 134 and slidably coupled with a coupling shaft 159 accommodated in a coupling shaft accommodator 155 of the main stand supporter 150. The guide 134 is provided to accommodate the main stand supporter 150 when folded to the rear casing 103.

The coupling track 134a is depressed along a lengthwise direction of the opposite sides of the guide 134. Thus, the coupling shaft 159 accommodated in the coupling shaft accommodator 155 of the main stand supporter 150 moves with the rotation of the main stand 130. The coupling track 134a may be larger than the diameter of the coupling shaft 159, thereby allowing the coupling shaft 159 to move up and down smoothly.

A grip part 135 may be provided in the lower part of the stand main body 131 so that a user adjusts the rotating angle of the main stand 130. The grip part 135 is cut with a predetermined size and has a proper length so that a user grips the grip part 135 easily with his/her hand.

The hook 137 is provided in the stand main body 131 to prevent the main stand 130 from being separated from the main body 100 when folded to the rear casing 103 and carried by a user. The hook 137 maintains a folded state with the main stand 130 by being accommodated in an accommodating part (not illustrated) provided in a first side of the rear casing 103 and corresponding to the hook 137. When a user presses the grip part 135 to the outside to rotate the main stand 130, the hook 137 is released from the accommodating part (not illustrated). On the other hand, when a user folds the main stand 130 from the rotated state, the hook 137 is accommodated in the accommodating part. Here, the hook 137 may be elastically accommodated in or released from the accommodating part.

A lower part 136 of the stand main body 131 directly contacting an installation surface may comprise a friction member such as a rubber material so that the main stand 130 does not slip on the installation surface while supporting the main body 100.

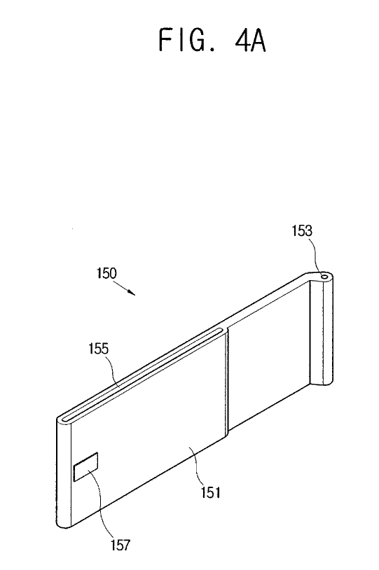

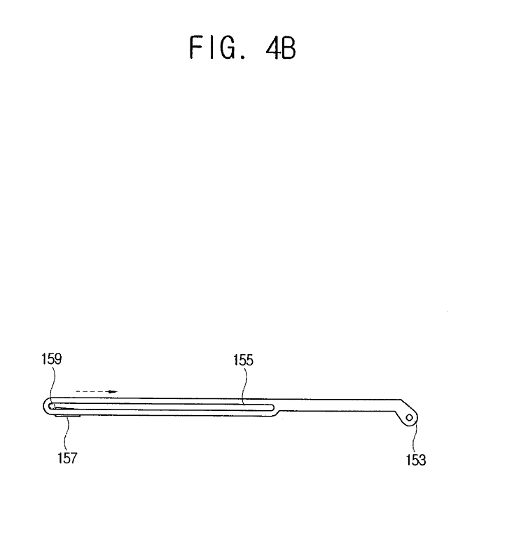

As illustrated in FIGS. 4A and 4B, the main stand supporter 150 may comprise a supporter main body 151, a second rotating shaft accommodator 153 which is provided in an end of the supporter main body 151, and accommodates the second rotating shaft 180 and is rotatably coupled with the rear casing 103, the coupling shaft accommodator 155 to accommodate the coupling shaft 159 as it moves with the rotation of the main stand 130, and a stopper 157 which protrudes from the coupling shaft accommodator 155 and restricts the movement of the coupling shaft 159.

The supporter main body 151 may have a plate shape. A part of the supporter main body 151 may be thicker than other parts thereof, due to the coupling shaft accommodator 155 as illustrated in FIG. 4A.

The supporter main body 151 may comprise an elastic material to be bent and support the main stand 130. The supporter main body 151 may comprise plastic.

The coupling shaft accommodator 155 may be elongated so that the coupling shaft 159 is accommodated therein as it moves. The length of the coupling shaft accommodator 155 may be the same as that of the coupling track 134a of the guide 134 of the main stand 130, thereby limiting the rotating angle of the main stand 130. As illustrated in FIG. 5, the coupling shaft 159 accommodated in the coupling shaft accommodator 155 moves with the rotation of the main stand 130 within the coupling shaft accommodator 155 and the coupling track 134a, and supports the rotating angle of the main stand 130.

Referring to FIG. 4B, the stopper 157 protrudes inside the coupling shaft accommodator 155 and limits the movement of the coupling shaft 159 moving within the coupling shaft accommodator 155. The stopper 157 may be provided in a second end of the main stand supporter 150 coupled with the main stand 130, and limits the movement of the coupling shaft 159 in an arrow direction, thereby restricting the rotating angle of the main stand 130. The stopper 157 may be placed in various positions within the coupling shaft accommodator 155 as necessary. Alternatively the stopper 157 may comprise a plurality of stoppers 157 to restrict the rotating angle of the main stand at various positions.

The auxiliary stand 140 may share the same rotating shaft with the main stand 130 to rotate in an optimal angle and to support the main body 100. Thus, a user may input information through the display part 110 at an optimal angle. The auxiliary stand 140 may comprise an auxiliary stand main body 141 having a plate shape, the rotating shaft coupler 143 which is provided in an upper part of the auxiliary stand main body 141 and accommodates the first rotating shaft 170, and a grip 145 to adjust an angle by a user (see FIG. 3).

The auxiliary stand main body 141 may have a plate shape, and corresponds to the auxiliary stand accommodator 132 of the main stand 130.

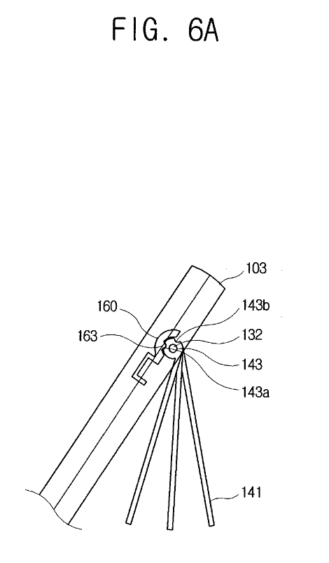

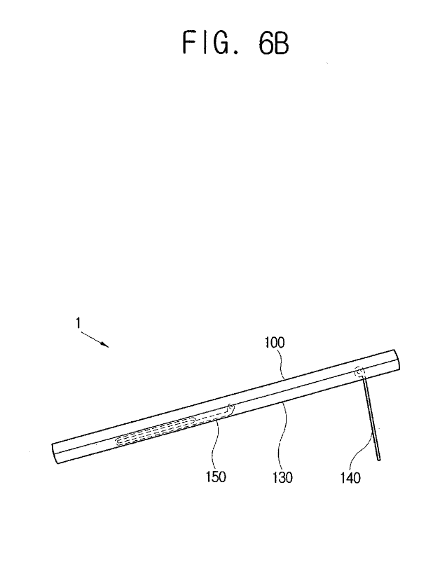

Referring to FIG. 6, the rotating shaft coupler 143 accommodates the first rotating shaft 170. The rotating shaft coupler 143 comprises a pair of projection accommodating grooves 143a and 143b which are provided in end parts thereof and accommodate the projection 163 formed in the shaft supporter 160 as illustrated in FIG. 6B. The projection accommodating grooves 143a and 143b accommodate the projection 163 and limit the rotating angle of the auxiliary stand 140 when the rotating shaft coupler 143 rotates around the first rotating shaft 170. The projection accommodating grooves 143a and 143b may be spaced from each other at various intervals according to the rotating angle of the auxiliary stand 140.

According to an embodiment of the present general inventive concept, the auxiliary stand 140 and the main stand 130 have the same rotating shaft, however, the present general inventive concept is not limited thereto. Alternatively, the auxiliary stand 140 and the main stand 130 may have different rotating shafts.

According to an embodiment of the present general inventive concept, the main stand 130 and the auxiliary stand 140 are provided in a central part of the rear casing 103, however, the present general inventive concept is not limited thereto. Alternatively, the main stand 130 and the auxiliary stand 140 may comprise a plurality of main stands 130 and a plurality of auxiliary stands 140 provided on the rear casing 103, respectively. Also, the number of the main stands may be different from the number of the auxiliary stands.

The main stand 130 and the auxiliary stand 140 may be provided in a lengthwise or transverse direction of the main body 100 according to a viewing direction of the display part 110. Alternatively, the main stand 130 and the auxiliary stand 140 may be provided in different directions with respect to each other.

Referring to FIGS. 3 to 6, a process of adjusting the supporting angle of the portable electronic device 1 according to an embodiment of the present general inventive concept will be described.

After installing the main body 100 on an installation surface, a user presses the grip part 135 of the main stand 130 folded to the rear casing 103 and separates the hook 137 from the accommodating part, to watch a movie or view multimedia information.

As illustrated in FIG. 5, when the main stand 130 rotates around the first rotating shaft 170, the main stand supporter 150 rotates around the second rotating shaft 180, thereby supporting the rotating angle of the main stand 130. When the main stand 130 rotates at an angle of “a”, the coupling shaft 159 of the main stand supporter 150 is positioned in a central part of the coupling shaft accommodator 155 and the lower part of the coupling track 134a, thereby supporting the main stand 130. When the main stand 130 rotates at an angle of “β”, i.e., an optimal viewing angle, the coupling shaft 159 moves to a free end of the coupling shaft accommodator 155 while passing the stopper 157, thereby having a stationary position. At this time, the coupling shaft 159 slides along the coupling track 134a and stops at a top part of the coupling track 134a. Also, the coupling shaft 159 supports the main stand 130 to limit the rotating angle of the main stand 130, thereby maintaining the optimal viewing angle stably.

When inputting information through the display part 110, a user presses the main stand 130 toward the rear casing 103 so that the hook 137 is accommodated in the accommodating part.

As illustrated in FIG. 6A, when a user presses the grip 145 of the auxiliary stand 140 to the outside, the projection 163 of the shaft supporter 160 accommodated in the first projection accommodator 143a of the rotating shaft coupler 143 is elastically separated therefrom, thereby rotating the auxiliary stand 140. When the projection 163 of the shaft supporter 160 is accommodated in the second projection accommodator 143b, the auxiliary stand 140 stops rotating, and the rotating angle is maintained.

When the auxiliary stand 140 is positioned on the installation surface, the main body 100 maintains the angle proper to input information by a user, as illustrated in FIG. 6B.

The information input angle may vary by adjusting the length of the auxiliary stand 140 or by adjusting the coupling position of the auxiliary stand 140 with respect to the main body 100.

As described above, the portable electronic device according to the present general inventive concept may comprise a main stand which adjusts a viewing angle when a user views multimedia information through a display part, and an auxiliary stand which adjusts an information input angle at which a user inputs information through the display part, thereby maintaining an optimal supporting angle.

The portable electronic device according to the present general inventive concept further may comprise a main stand supporter which supports a rotating angle of the main stand to maintain a viewing angle.

The main stand and the auxiliary stand are accommodated in a rear casing of a main body of the portable electronic device, thereby providing a slim external appearance and being carried by a user without difficulty.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A portable electronic device comprising:
a main body;
a display part provided in the main body to display an image thereon;
a main stand which is coupled with a rear part of the main body to adjust a supporting angle of the main body; and
an auxiliary stand which is coupled with one of the main body and the main stand, to adjust the supporting angle of the main body.

2. The portable electronic device according to claim 1, wherein the main stand and the auxiliary stand are coupled with a same hinge shaft.

3. The portable electronic device according to claim 1, wherein the main stand and the auxiliary stand are coupled with different hinge shafts, respectively.

4. The portable electronic device according to claim 3, further comprising:
a main stand supporter having a first end rotatably coupled with the rear part of the main body, and a second end coupled with the main stand to support the main stand and maintain the supporting angle of the main stand with respect to the main body.

5. The portable electronic device according to claim 4, wherein the second end of the main stand supporter is slidably coupled with the main stand.

6. The portable electronic device according to claim 5, wherein the main stand supporter comprises:
a coupling shaft accommodator which is formed along a lengthwise direction thereof and accommodates therein a coupling shaft slidably coupled with the main stand; and
a stopper provided in a first end of the coupling shaft accommodator to limit a movement of the coupling shaft.

7. The portable electronic device according to claim 5, wherein the main stand comprises a coupling track with which the coupling shaft is slidably coupled.

8. The portable electronic device according to claim 6, wherein the main stand supporter comprises an elastic material.

9. The portable electronic device according to claim 6, wherein the main stand comprises an auxiliary stand accommodator which accommodates the auxiliary.

10. The portable electronic device according to claim 2, further comprising:
a main stand supporter having a first end rotatably coupled with the rear part of the main body, and a second end coupled with the main stand to support the main stand and maintain the supporting angle of the main stand with respect to the main body.

11. The portable electronic device according to claim 10, wherein the second end of the main stand supporter is slidably coupled with the main stand.

12. The portable electronic device according to claim 11, wherein the main stand supporter comprises:
a coupling shaft accommodator which is formed along a lengthwise direction thereof and accommodates therein a coupling shaft slidably coupled with the main stand; and
a stopper provided in a first end of the coupling shaft accommodator to limit a movement of the coupling shaft.

13. The portable electronic device according to claim 11, wherein the main stand comprises a coupling track with which the coupling shaft is slidably coupled.

14. The portable electronic device according to claim 12, wherein the main stand supporter comprises an elastic material.

15. The portable electronic device according to claim 12, wherein the main stand comprises an auxiliary stand accommodator which accommodates the auxiliary stand.

16. The portable electronic device according to claim 1, further comprising:
a main stand supporter having a first end is rotatably coupled with the rear part of the main body, and a second end coupled with the main stand to support the main stand and maintain the supporting angle of the main stand with respect to the main body.

17. The portable electronic device according to claim 16, wherein the second end of the main stand supporter is slidably coupled with the main stand.

18. The portable electronic device according to claim 17, wherein the main stand supporter comprises:
a coupling shaft accommodator which is formed along a lengthwise direction thereof and accommodates therein a coupling shaft slidably coupled with the main stand, and
a stopper provided in a first end of the coupling shaft accommodator to limit a movement of the coupling shaft.

19. The portable electronic device according to claim 17, wherein the main stand comprises a coupling track with which the coupling shaft is slidably coupled.

20. The portable electronic device according to claim 18, wherein the main stand supporter comprises an elastic material.

21. The portable electronic device according to claim 18, wherein the main stand comprises an auxiliary stand accommodator which accommodates the auxiliary stand when the auxiliary stand is folded to the main body.

22. The portable electronic device according to claim 1, wherein the main stand and the auxiliary stand are different in height.

23. The portable electronic device according to claim 22, wherein the main stand comprises an auxiliary stand accommodator which accommodates the auxiliary stand.

24. The portable electronic device according to claim 1, further comprising a shaft supporter provided in the rear part of the main body to support the hinge shaft of the auxiliary stand.

25. The portable electronic device according to claim 24, further comprising:
a pair of projections disposed at a first side of the shaft supporter at a predetermined angle; and
a pair of projection accommodating grooves disposed at a hinge shaft accommodator of the auxiliary stand to accommodate the projections and to limit a rotating angle of the auxiliary stand.

26. A portable electronic device comprising:
a main body;
a display part disposed in the main body to display an image;
a main stand rotatably coupled with a rear part of the main body to support a plurality of first angles of the main body with respect to an installation surface; and
an auxiliary stand rotatably coupled with one of the main body and the main stand to support a plurality of second angles of the main body with respect to the installation surface.

27. The device of claim 26, wherein the main stand comprises:
an auxiliary stand accommodation portion to accommodate the auxiliary stand;
a plurality of rotating shaft portions to accommodate a first rotating shaft and to rotatably couple the main stand to the main body; and
a grip part disposed on an opposite side to the rotating shaft portions to allow a user to rotate the main stand.

28. The device of claim 27, wherein the auxiliary stand comprises:
a plurality of rotating shaft couplers to accommodate a second rotating shaft and to rotatably couple the auxiliary stand to the main body; and
a grip part disposed on an opposite side to the rotating shaft couplers to allow a user to rotate the main stand.

29. The device of claim 28, wherein the first rotating shaft and the second rotating shaft comprise the same shaft, and the plurality of rotating shaft couplers are disposed between the plurality of rotating shaft portions.

30. The device of claim 26, further comprising:
a main stand supporter having a first end rotatably coupled to the rear part of the main body and a second end slidably coupled to the main stand, to support the main stand and maintain the plurality of first angles of the main stand with respect to the main body.

31. The device of claim 30, wherein the main stand supporter comprises:
a second rotation shaft accommodator to accommodate a shaft and to rotatably couple the main stand supporter to the main body; and
a coupling shaft accommodator to accommodate a coupling shaft to slidably couple the main stand supporter to the main stand.

32. The device of claim 31, wherein the main stand further comprises a coupling track to guide the coupling shaft.

33. The device of claim 30, wherein the coupling shaft accommodator further comprises a stopper to restrict the rotation of the main stand at the plurality of first angles.

34. A portable electronic device, comprising:
a main body;
a display part disposed in the main body to display an image; and
a stand unit rotatably coupled with a rear part of the main body and including a first part to rotate out from the main body to provide a first set of angles to support the main body with respect to an installation surface and a second part to rotate out from the main body to provide a second set of angles to support the main body with respect to the installation surface.

35. The portable electronic device of claim 34, wherein the first part and the second part of the stand unit are together rotatably coupled at first respective sides thereof to the rear portion of the main body.

36. The portable electronic device of claim 34, wherein the stand unit further comprises a shaft to rotatably couple the first and second part of the stand unit together to the rear portion of the main body.

37. The portable electronic device of claim 34, further comprising a shaft supporter disposed at the rear portion of the main body to support the stand unit and to support the second set of angles.

38. The portable electronic device of claim 37, wherein the shaft supporter is integrally formed with the rear portion of the main body.
